(19) United States
(12) Patent Application Publication
(10) Pub. No.: US 2013/0018808 A1
(43) Pub. Date: Jan. 17, 2013

(54) MULTI-PARTY LEGAL ENFORCEMENT SYSTEM AND METHOD

(71) Applicants: Martin Schwartz, Brooklyn, NY (US); Joseph Rosenbaum, Brooklyn, NY (US)

(72) Inventors: Martin Schwartz, Brooklyn, NY (US); Joseph Rosenbaum, Brooklyn, NY (US)

(73) Assignee: CASEACT LLC, Brooklyn, NY (US)

(21) Appl. No.: 13/180,115

(22) Filed: Jul. 11, 2011

(51) Int. Cl. G06Q 50/00

(52) U.S. Cl. 705/311

(57) ABSTRACT

A system and method for implementing a resolution to a landlord tenant dispute. In an embodiment, a database stores party information, legal form information and case information. First electronic case information representing a dispute is received and a petition for evicting at least one tenant associated with the dispute is generated and transmitted to a process server. Second electronic case information representing additional information associated with the dispute is received, and one or more actions and corresponding schedules for implementing the eviction are determined. One or more of copies of court documents associated with the eviction, the one or more actions and corresponding schedules; and the first electronic case information is provided, for example, over the Internet. The actions due are tracked for completion, and alert(s) representing that at least one of the one or more actions is coming due or is past due are transmitted to a party associated with the at least one of the one or more actions. Thereafter, a warrant for implementing the eviction is ordered.

### BACKGROUND

1. Field

The present application relates, generally, to landlord/tenant processes and enforcement and, more particularly, to a system that provides a standardized, easily accessible, computerized facility that simplifies, expedites, facilitates, and integrates tracking of said legal transactions by multiple parties and entities in a manner that reduces errors and expedites a completion of said legal transactions.

2. Description of the Related Art

Various parties are associated with cases involving real estate evictions of residential or commercial tenants. For example, attorneys work in the court systems with landlords (or their agents) to obtain the legal bases for evictions. Additionally, actions are taken by process servers and marshals, who serve notice and may ultimately evict tenants or otherwise reach settlement.

Each of the parties associated with evictions have various information and financial requirements, which need to be managed properly and coordinated with other actions in order to ensure that evictions are carried out promptly and efficiently. For example, court documents need to be distributed and accessed, and confirmations, and various reference data, including relating to management personnel, superintendent data, affidavits of non-compliance and default judgments may need to be referenced and relied upon for an eviction to occur.

Often, paper copies are facsimiled to various parties or e-mail attachments are transmitted, and information associated therewith is not managed well, thereby causing errors and delays in the eviction process. Other errors occur when, for example, parties' demographic information is not managed well, dates are missed, papers are missing, and fees are not paid.

### SUMMARY

Accordingly, it is an object of the present invention to provide a landlord/tenant process handling system which is standardized, easily accessible and a computerized facility for resolving a matter including, but not limited to, facilitating collection of tenant arrears or reclaiming property, which may include evictions of tenants.

It is a further object of the invention to provide a real estate dispute handling system that simplifies, expedites, facilitates and integrates tracking of legal transactions by multiple parties, including landlord, attorney, marshal and legal and non-legal entities, in a manner that reduces errors and expedites completion of the legal transactions.

It is yet another object of the invention to provide a unified computerized system tracking for landlord/tenant real estate matters, which is usable by attorneys, landlords, their agents, and marshals responsible for resolving such disputes.

The foregoing another object of the invention are realized by a system and method for implementing resolutions of real estate disputes, which in one embodiment thereof includes a database which stores party information, legal form information and case information. First electronic case information representing a dispute is received and a petition for evicting a tenant or tenants associated with the dispute is generated and transmitted to a process server. Second electronic case information representing additional information associated with the dispute is received, in one or more actions and corresponding schedules for resolving the dispute are determined.

In accordance with the system and method, one or more copies of core documents associated with the dispute, as well as with the one or more actions and corresponding schedules and the first electronic case information is provided over a computer accessible facility, for example, at a desktop computer which accesses the system over the internet. The actions due are tracked for completion and alerts representing the one or more actions that are coming due or that are past due are transmitted to a party associated with the particular dispute. Ultimately, the system produces all the information to produce a warrant for resolving the dispute.

In accordance with a more detailed description of an embodiment of the system for implementing a resolution to a dispute, such a system includes: one or more processor readable media that are operatively coupled to one or more processors; at least one database stored on the one or more processor readable media comprising: i) electronic party information including information representing a plurality of parties respectively associated with a plurality of disputes; ii) electronic legal form information representing templates for legal forms; and iii) electronic case information representing a plurality of dispute-related cases; wherein the one or more processors are programmed and configured to perform the following steps: receive from a first computing device, first electronic case information representing a dispute; generate, using at least some of the electronic legal form information, a petition for evicting at least one tenant associated with the dispute; transmit the petition to a second computing device associated with a process server; receive, from at least one of the second computing device and a third computing device, second electronic case information representing additional information associated with the dispute; determine, based at least on the first and second electronic case information, one or more actions and corresponding schedules for resolving the first dispute; provide, over a communication network, as a function of the determining, at least one of: i) one or more copies of court documents associated with the dispute; ii) the one or more actions and corresponding schedules; and iii) the first electronic case information; track that each of the one or more actions is completed; generate and transmit one or more alerts representing that at least one of the one or more actions is coming due or is past due to a computing device associated with a party associated with the at least one of the one or more actions; and, for example, order a warrant and track processes through completion.

Features and advantages of the present application will become apparent from the following description of the invention that refers to the accompanying drawings.

### BRIEF DESCRIPTION OF THE DRAWINGS

For the purpose of illustrating the invention, there is shown in the drawings several forms, which are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement in accordance with an embodiment of the present application;

FIG. 2 illustrates functional elements, of which one or more may be configured in an computing device in accordance with an embodiment;

FIGS. 3A and 3B illustrate an example flow chart of a simplified process identifying case initiation through the order warrant phase;

FIG. 4 is a flow chart illustrating a processing scheme associated with an embodiment;

FIG. 5 illustrates an example display that represents a case history for a particular matter in accordance with an embodiment;

FIG. 6 illustrates an example display that lists cases with upcoming eviction dates, in accordance with an embodiment;

FIG. 7 illustrates an example display that lists cases for a respective address;

FIG. 8 illustrates an example display that represents an example stipulation, in accordance with an embodiment;

FIG. 9 illustrates an example display that lists locations by agent for upcoming cases, in accordance with an embodiment;

FIG. 10 illustrates an example display for selecting pending actions for all cases, in accordance with an embodiment; and

FIG. 11 illustrates an example display that lists upcoming vacate dates, in accordance with an embodiment.

### DESCRIPTION OF EMBODIMENTS

The present application provides systems and methods for tracking and expediting landlord/tenant cases. By facilitating process tracking, and document production, legal cases are monitored and managed to preclude missing a critical date or legal action. Preferably, the teachings herein are implemented in a custom web-based environment, and access to database software and program routines provide for tracking, production of draft attorney documentation, and resolution of landlord tenant cases through the landlord/tenant court system. Using a proprietary web based front-end, the application ties together key players. For example, landlord, agent, attorney and marshal are tied together as a function of the present application, thereby enabling process flow communication therebetween.

In an embodiment, case team parties (e.g., attorneys, landlords, tenants, marshals and process servers) are notified instantly of any case status updates that have taken place as a result of actions undertaken by other team parties. This is provided as a function of web-based case update capability, and cases are automatically updated as cases proceed. In an embodiment, batch output is supported e.g., e-mail, messaging, printing, or the like, such that production of alerts and documents are generated and sent regularly (e.g., each morning and afternoon) by facsimile and e-mail to the appropriate parties. In an embodiment, specially formatted reports are sent to smartphones as well.

Moreover, attorney-drafted documents are preferably created and transmitted to appropriate people, and landlords striving to evict a tenant use the teachings herein to view and update statuses of all cases with a click of a mouse or other selection device. By providing information in an Internet web environment, items that need attention are displayed, as well as various other information. For example, the current statuses of cases, as well as flags for respective items the need a response are easily identified and monitored. Other information that is disseminated includes court results, such as copies of documents, smart summaries or the like, as well as expected next steps that are coming due for cases. Additionally, the teachings herein support maintaining calendar information for dispute-related events, including evictions, access dates, and court dates, and alerts associated with various activities and conditions are generated and transmitted. Moreover, information is preferably provided to various parties, such as instructions to a marshal how a respective warrant is to be served (e.g., via a tenant attorney, legal guardian or via electronic service).

Eviction package(s) are also provided that assure that all paperwork needed for evictions are available, thereby reducing likelihood that a case will get delayed. Further, when a warrant is issued, the marshal is notified by one or more alerts and/or messages to pick up the warrant, and payments by an attorney that are associated with the marshal and/or process server are preferably tracked for compliance.

Thus, the teachings herein provide a comprehensive system and method from case initiation through, for example, the order warrant phase associated with resolving landlord/tenant disputes, including evictions, and continuing through final resolution of the matter.

One embodiment includes usage by an agent who hires his own attorney. In this embodiment, functionality is provided to apprise the agent of the statuses of his cases, which are used by him to gauge the efficiency of the process, and to send alerts to the attorney and the marshal of future steps to be taken. This prevents one or more cases from “falling through the cracks.” Intelligent backend processes are employed to record results of court proceedings, and to make them available in reports to various media including smartphones, the web, and specialized e-mailed and auto-facsimiled reports.

In another embodiment, the system will be used by an attorney to generate draft forms used in the landlord/tenant process such as petitions, warrants, motions, affidavits, etc., provide the web software as a service to his clients, and events are substantially automatically inserted into the cases as feasible on schedule in order to move the cases forward, in addition to other functionality described herein.

Preferably, the key players in the system are kept up to date of current statuses and can update cases in real-time, passing the case to the next phase and alerting the next required team player of any new steps required on his part.

In an embodiment, a system is comprised of a web service accessible by the agents, attorneys, and marshals, and internal .net, and SQL Server database system components for alert processing, event generation, processing of stakeholder correspondence, calendaring, and production of drafted court documents. These technical innovations coupled with optimized procedures and followed by staff comprise a complete solution.

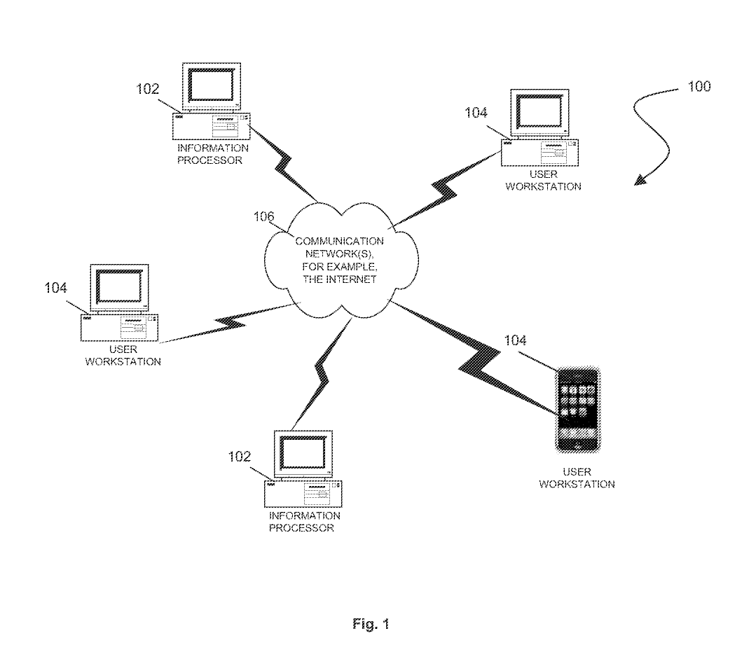

Referring now to the drawing figures, in which like reference numerals represent like elements, FIG. 1 illustrates an example hardware arrangement in accordance with an embodiment of the present application. Referred to generally, herein, as system 100, the arrangement provides for monitoring and notification services in accordance with the teachings herein. System 100 includes at least one information processor 102 (configured to operate as an Internet web server and/or database file server) that is programmed and configured to access communication network 106 and communicate with computing device(s) 104. Computing devices 104 may be personal computers, and may further be mobile devices, such as operating one or more of the GOOGLE ANDROID, APPLE IOS, WINDOWS MOBILE operating systems, and may include smartphone devices, tablet computing devices, other mobile portable devices. Computing devices 104 and information processor(s) 102 may communicate via the known communications protocol, Transmission Control Protocol/Internet Protocol “TCP/IP.” Information processor 102 and computing device(s) 104 preferably are provided with or have access to all databases necessary to support the present application.

Communication network 106 is preferably a global public communication network such as the Internet, but can also be a wide area network (WAN), local area network (LAN), an intranet or other network that enables computing devices and peripheral devices to communicate.

In a preferred embodiment, information processor(s) 102 and computing devices 104 are preferably equipped with web browser software, such as MICROSOFT INTERNET EXPLORER, MOZILLA FIREFOX, APPLE SAFARI or the like. Information processor 102 and computing devices 104 are coupled to communication network 106 using any known data communication networking technology.

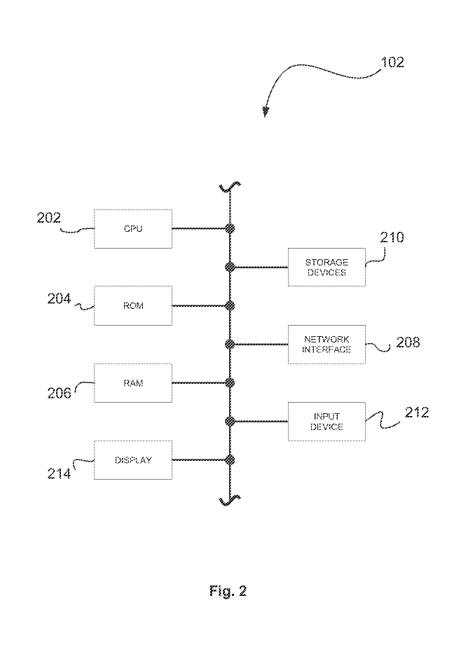

FIG. 2 illustrates functional elements, of which one or more may be configured in an example information processor 102 and/or computing device 104. The functional elements shown in FIG. 2 include one or more central processing units (CPU) 202 used to execute software code and control operations. Other elements shown in FIG. 2 include read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code databases and application data, one or more input devices 212 such as a keyboard, mouse, track ball, microphone and the like, and a display 214.

The various components illustrated in FIG. 2 need not be physically contained within a single device chassis or even located in a single location. For example, storage device 210 may be located at a site that is remote from the remaining elements of information processor 102, and may even be connected to CPU 202 across communication network 106 via network interface 208. Information processor 102 and/or computing device 104 may include a memory equipped with sufficient storage, such as to provide or access the necessary databases, forums, and other community services communicating hypertext markup language (HTML), Java applets, Active-X control programs. Information processor 102 and/or computing device 104 are arranged with components, for example, those shown in FIG. 2, suitable for the expected operating environment. The CPU(s) 202, network interface(s) 208 and memory and storage devices are selected to ensure that capacities are arranged to accommodate expected demand.

The nature of the present application is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL and PHP.

Although the present application is described by way of example herein and in terms of a web-based system using web browsers and a web site server (e.g., information processor 102), system 100 is not limited to such a configuration. It is contemplated that system 100 is arranged such that information processor 102 and/or computing devices 104 communicate with and outputs data using any known communication method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 102 and/or computing device 104, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, WINDOWS 7, MAC OS, UNIX, LINUX, PALM OS, POCKET PC, BLACKBERRY, ANDROID, IOS and any other suitable operating system.

Preferably, various documents, such as legal documents, are stored in one or more databases and indexed for use by one or more parties associated with the present application. Documents that are stored or otherwise accessible by one or more information processors 102 are substantially automatically assigned to an appropriate department or party for one or more actions. Moreover, information representing one or more individuals is stored or otherwise accessed by one information processor(s) 102 and determinations are made thereby to assign a given document to be acted on by a particular person.

In an embodiment, a proprietor of the teachings herein has access to a staff, including administrative staff, and documents are respectively assigned to staff personnel for various appropriate activity. For example, a particular legal document is accessed by information processor 102, and the document is categorized and opened in an appropriate display screen provided with computing device 104 This enables one or more staff or other personnel to work with the information provided in the document. Preferably, functionality is provided to ensure that one or more required data entry fields are entered correctly. As data are entered, programming functionality is provided to prompt for additional information in appropriate contexts, thereby ensuring that a case moves forward by entering the correct next event.

Examples of functionality provided in accordance with the teachings herein are now provided below.

Stipulation Processing. Various stipulations (also referred to herein as “stips’) have respective court disposition documents associated therewith. In a typical example, the stipulation includes an original handwritten court document describing the terms and conditions, which is often hard to decipher. In one embodiment, an image of the actual, handwritten stipulation is displayed or otherwise made available for users. In addition, the court disposition may contain the attorney's summary of the stipulation. Accordingly and in addition (or in the alternative), the summary of the contents of the stipulation are displayed which includes the attorney's summary of the stipulation. Information processor(s) 102 may be configured to display a plurality of views, including in a plurality of workstation display screens. When a respective staff member who is assigned to a respective stipulation accesses the stipulation document, one or more associated court disposition documents are provided such that each document can be separately managed. Once it is confirmed that the disposition contains all the information mentioned in the stipulation, a copy of the stipulation is preferably automatically updated, for example to a web page, thereby giving clients an opportunity to view respective stipulations on-line in real time. This provides improved accessibility and eliminates the need for paper files.

The system automatically opens up a data entry screen with a menu of possible terms and conditions that can appear on a stipulation, which a staff member uses to enter the stipulation terms. In an embodiment, the display provides controls for the user to enter notes, schedules, calendar information, and the like, as appropriate. In an embodiment, the data entry screens are designed to closely mimic the original Court Disposition form(s), which are familiar and serve to minimize errors.

Once terms and conditions, and other relevant information, are entered, a stipulation summary is preferably provided which is instantly available, for example, on a web page, and is preferably provided in one or more daily alerts which get sent to agents, such as via e-mail, messaging or other suitable way.

After stipulations are entered, a report is preferably generated listing, for example, missing stipulations, and/or disposition forms for the day, and unacceptable copies of the stipulation and/or copies of the disposition form, which is usually prepared daily. Staff takes the data off the stipulation and updates the database. The report may be provided as an alert, which goes out daily to an attorney to notify the attorney to supply one or more missing documents.

After the stipulation terms and conditions are entered in the system, a scan for events in need of immediate attention, such as Final Judgment Forthwith, Defaults, Serve/Re-mail Forthwith, or the like, is conducted to alert the appropriate team member via an on-line graphical user interface, referred to herein as a “web dashboard.” In addition, tracking functionality may be later conducted to ensure that appropriate and timely action has been taken.

In an embodiment, dashboard screens display case information and identify cases requiring a response with a decision in one place in real-time. Further, reports generated via dashboards may be provided, and include: all tenants who are past due per the stip; all cases ready for warrant application to be ordered; all tenants with issued warrants ready to be served; all tenants with expired vacate dates per the stip; report of all monies collected in court confirming the client has received; a report of all apartments given possession by marshal for user to confirm discontinues of case; a report listing all cases in Holdover status with date expired for case to proceed and post current balance; and a report listing all cases ready for warrant application put on hold for further direction. Users are able, via the dashboards and associated reports, to get a quick overview of the court results on all cases filtered by per defined time frames, (e.g., today, last two days etc.) and reports display all aspects of the case including copies of all documents. Other types of information provided in accordance with an embodiment include web displays a list of all properties filtered by agent; lists of all open cases filtered by borough/Agent/Address/Index Number; Calendar information of upcoming evictions, court cases and repair access dates filtered for any time frame. In an embodiment, calendar information may be exported to one or more third party applications, including MS-OUTLOOK or other calendar applications.

The one or more dashboards provided in accordance with the teachings herein provide, among other things, case status information substantially in real time, and users may view copies of stips, orders, decisions and case summaries in convenient and easy-to-read formats. Further, response column flags are preferably provided in various contexts for items where user input is appropriate. For example, a user submits decision information with a click of a mouse, which automatically updates the system with a report, document, or alert to appropriate parties.

Among some dashboards provided herein are included a marshal dashboard, an attorney dashboard and a landlord dashboard. The marshal dashboard may include, for example, all cases waiting for docket to be purchased, cases where user wants to have the warrant served, cases where warrant has been served that are in need of an eviction date, and cases that are settled for eviction in the next two days where the marshal can confirm that the date is still valid. The attorney dashboard may, for example, update the attorney with the list of tenants a landlord would like to order a warrant, identify cases where action needs to be taken per stipulation for attorney's update of status, and identify cases where payments became due and the landlord has been advised that payment has not been made. The attorney needs to update the case status.

In an embodiment, a clock or similar control is started for tracking one or more time sensitive stips; for instance defaults aged; and final judgments 5 or 10 days. The present application may track and alert appropriate people on an appropriate day, so that the warrant application will be submitted on time. The system preferably also tracks to make sure that appropriate and corresponding events are being taken care of.

In an embodiment and in the case of a repair access date, a payments due date or a vacate date, the system may display one or more dates on-line (e.g., on the internet and world wide web). Alerts may be generated for one or more agents on the day prior to an “Access” date and if, for example, the conditions of the payment date or vacate date have not been met.

In an embodiment, if a stipulation shows money was collected in court, information may appear in the web dashboard up to, for example, five days later, and the agent will be queried to make sure that the money was received.

In an embodiment, incoming e-mails, including attachments, are processed for possible outgoing facsimileing and or to be assigned to a party's queue. When an e-mail is open, it is preferably assigned to someone's queue, a page type is entered and an index number is assigned. Incoming facsimiles are similarly assigned to a party's queue, and a page type and an index number are assigned. In-house reports are preferably automatically assigned to queues daily. Similarly, stipulations may be received as a facsimile, and are assigned to a party's queue, entered as a page type and assigned an index number. Stipulations are preferably uploaded to an Internet web site, and are preferably indexed to represent details. Other documents, such as court documents and warrants, are preferably managed by submitting descriptions, identifying court dates, rooms, times or the like for reference.

In another example and if a stipulation comes in on a two name case, a determination is made to query which was a default, and which was after trial. If the information is not supplied with the stipulation, then copies of the judgment are preferably obtained (either substantially automatically or via one or more manual processes) to determine which respective tenant was default and which was after trial.

In an embodiment, one or more of the following features may be supported:

(1) All documents attached to a case are obtainable (e.g., displayable, printable or the like).

(2) Upcoming evictions may be displayed in the marshal dashboard.

(3) Marshal confirms evictions, for example, by submitting information via a web interface, and enters the scheduled eviction time.

(4) Appropriate staff executes an “Eviction Print” function to e-mail/facsimile (or send via currier, regular postal mail or other physical way) required eviction forms to the landlord/agent for all confirmed evictions that are scheduled for the following day. In an embodiment, a package is assembled from the eviction print includes: Cover sheet describing the documentation required; Affidavits of non-compliance if the system decides that it is required; and a form asking for any other information needed for the eviction.

(5) Client returns the package documents via e-mail/facsimile. Appropriate staff marks each document appropriately, such as Complete upon receipt.

(6) On the day of eviction, a list of the day's evictions along with a checklist of the items that need to be checked for each one is preferably provided by the system. The list may include, for example: Check if eviction is legal-check tenant breakdown to ensure stipulation amount (or petition amount if never in court) was not paid; Check whether the non-compliance was notarized for those cases that need a non-compliance; Check the access details for any eviction info; Check whether the client wants a truck (if client wants a truck, a truck order form is preferably provided); and Try to get the stipulation if the stipulation is not in the system.

(7) Missing Agent Feedback In-house report may be produced that shows evictions with missing documents.

(8) Produce a package containing enclosures for one or more of evictions with completed documentation for marshal evictions are printed automatically and addressed appropriately, and preferably e-mailed/facsimiled.

The Marshal Package includes: Final Confirmation; Superintendent's information; Affidavit of non-compliance; and Defaults.
A user selects “Print Attorney Eviction Package” graphical screen control to e-mail/facsimile the necessary eviction information to the attorney for all evictions scheduled for the day.

Preferably, batch alert generation and reporting functionality is provided in accordance with an embodiment. At certain predefined time(s) during the day, reports are generated and emailed/faxed to appropriate team members who are involved in a respective case.

A discussion regarding report and other output features provided in accordance with one or more embodiments is now provided.

Report Routing:

(1) Any combination of facsimile numbers and e-mail addresses be set up for default delivery location(s) for one or more agents, attorneys, marshals or other parties

(2) One or more destinations may be defined per report, for example, to provide an override option of the default location.

Report scheduling: Each report may be scheduled for a particular time for production, e.g., nighttime, midday, or the like, or a specific time.

Report Generation Engine: In an embodiment, an engine runs one or more reports according to a specified schedule specified, parses the report, and transmits it (e.g., via e-mail, facsimile or via currier, regular postal mail or other physical way) according to routing destination information entered in the routing component.

Types of Reports

(1) Attorney drafted court documents that need to be signed and notarized by the agents

(2) Automated alert reports notifying the agents, attorneys, and marshals to items that require their attention

(3) Attorney calendars, and court dispositions for upcoming court dates.

Alerts: In embodiment, alerts may be sent via facsimile, e-mail and/or other suitable way to various parties, including, for example, attorneys, landlords, marshals and process servers. The users may define one or more lists of e-mail addresses and/or facsimile numbers for report distribution, and may also request that a given report be sent to an override location. Various versions of key alerts that have been optimized to be viewed on a smartphone. These are preferably in addition to alerts that are provided on the Internet and world-wide-web.

In an embodiment, alerts that require responses from one or more parties are distributed on the Internet, which supports interactivity.

In-House alerts are generated for in-house staff and provide, for example, reports of cases that are waiting for action from one or more parties, such as the marshal, landlord/agent or attorney or process server.

Agent alerts are provided that identify, for example, access dates, money collected in court, upcoming court dates, missing breakdown, stipulation summary (which may be provided via one or more respective devices (including) BLACKBERRY, IPHONE, or other devices. Examples of agent alerts include: Evicted—Discontinue; Eviction due 2 day advance; Affidavit of non-compliance 2 day advance; Evictions due one day in advance; Eviction info form; Payments Past Due report; Vacate Date Past Due report; Warrant received/Serve warrant.

Other examples of agent alerts (and corresponding reports) may include: Holdover expiration date; Affidavit notice of motion; Waiting for affidavit notice of motion; Waiting for motion info; Rent Demand Expired/want to dispossess report; Affidavit of Merit; Affidavit of Merit 2 name case; List of warrants on hold; Affidavit of noncompliance warrant; Order warrant; Waiting for affidavit of merit; Waiting for warrant affidavit of non-compliance and Items still needing attention.

In addition to agent alerts, a plurality of attorney alerts are supported by the teachings herein and include: Upcoming court dates; Court Disposition forms; Missing court documents; Warrant Intake sheet(s). Various attorney notifications may include: cases that can be re-mailed forthwith; Cases that need an affidavit of non-compliance; Cases where tenant defaulted on payment; Cases where the agent asked to dispossess; Cases requiring a Section 8 subpoena; Cases requiring an affidavit of merit; Cases requiring a motion of discontinuance; Cases requiring a non compliance for a warrant; Cases requiring a Notice of Discontinuance; and Cases requiring a warrant to be ordered.

Alerts may also be provided that represent marshal alerts, and include: Items for attention (e.g., alerts the marshal to go to a web page and respond to open items); List of Evictions due; and Follow up after eviction date.

In connection with enforcement, payment of fees associated with enforcement is preferably supported by the teachings herein. Accordingly, a system and method for streamlining payables and billing matters is provided to cover billable events associated with an attorney, marshal, and process server. Features included are price tracking and providing payable reporting.

Price tracking: When a client signs up or is otherwise affiliated with the teachings herein, he provides a list of the attorneys, marshals and process servers that he uses for his cases. Appropriate staff receives up-to-date price lists from each of these vendors for each service, and updates these prices in the event pricing system. Staff preferably periodically reaches out to these vendors to verify that the prices are still accurate

Payable Report: At the beginning of each month, the system sends a report of all items performed by each member of the team, attorney, marshal and process server covering all billable events for the previous month. Each item is followed by a price, with a grand total at the end. With the knowledge that all events for his cases are accurately tracked, the client simply sends the report to the attorney, marshal and process Server, along with the payment.

Benefits: Prior to the development of this service, the client's staff had to spend many hours reconciling the attorney, marshal and process Server end of month bills. In accordance with the teachings herein, various parties (including, for example, attorneys, marshal and process server) enjoy a tremendous time saving, and reduction of overhead and cost savings.

Another feature of the present application includes an automated event entry engine. In one or more cases, there may be events that cannot be completed before a certain time is up. For example, a final judgment typically requires five days. Normally, many of these events are overlooked, which results in delays. To address this concern, a batch case review engine is provided that goes through all active cases, and determines that a case can be moved forward because the time has come. Preferably, a correct event is scheduled, and which moves the case to the next level.

A discussion regarding workflows and user activity in connection with an embodiment is now provided.

(a) Rules: Workflow rules are defined to ensure that events are entered in the proper sequence, and events are not erroneously entered by the staff

(b) Alerts: In an embodiment, alerts are generated in a work queue. Work queue alerts are provided as a supervisory overview of workflow, assignments, and work that is due to be performed. In an embodiment, work queue alerts pertain to warrants to be ordered, evictions coming due, and petitions and/or motions to be printed. Example events include: warrants are to be ordered; evictions are due; petitions need to be printed; motion documents are to be printed. The supervisor can view each staff members queue to ensure that all matters have been taken care of.

Example events that are monitored via various alerts generated by the system are provided below. Each alert may be placed on the work queue of the department that has responsibility for the issue.

(a) Money collected in court—Follow up with the attorney for all cases where the agent notified staff via the web that money was not received.

(b) Maintain Court Calendar—Staff keeps track of all upcoming court dates

(c) Tracking: Tracing of missing court docs: Breakdown; Stips; Judgments; Court Dispositions; Defaults; and Judgments.

(d) Marshal events follow up: This may include things the marshal should have taken care of, but do not appear to be completed. Further, if a warrant has been issued, staff is alerted to follow up with the marshal to ensure that the marshal has received delivery.

Eviction Tracking—Preferably, an eviction checklist is provided for the determining which documents are required for each respective case, and items are identified for the staff to ensure that all documentation is complete. Moreover, a list of evictions scheduled is preferably provided for any given day.

Motion Tracking—Preferably, legal motions are tracked, for example, for the following conditions: Waiting for Motion Confirmation; Waiting for Affidavit Notice of Motion from Agent; and Tracking of Aged Motion events.

Additionally, index number tracking is supported, for example, to track old dispossesses that are not provided with index numbers. Other tracking includes Petition Tracking (e.g., for Aged Affidavit of Service), Warrant Tracking (e.g., for Aged Warrant event tracking, Waiting for Dockets, Waiting for Notice of Discontinue Confirmation and Warrants that are Rejected).

The present application also supports case data error checking, and may incorporate checks and balances to ensure that case data is correct. This may include, among other reports: Checks for illogical events; Checks where case status and events don't match; Highlights cases where key data was changed; Cases where data is incomplete; Web log discrepancy report; and Cases that have been inactive for more than 30 days.

In addition to error tracking, miscellaneous functional pointers are supported for the following categories:

1) Items requiring attention get displayed on-line via the web on one page/dashboard (Control Center) for the parties (e.g., attorney, landlord, and marshal);

2) Parties are prompted to respond to reports on web dashboard with a click; automatically updating the database and moving the case forward in its process.

3) Information that is updated gets received automatically by the parties, (e.g., the attorney, marshal, and agent), and one or more of the parties are prompted for the next step that is to be completed or other is otherwise required.

Intake Process:
Print rent demand
Calculate when able to dispossess (nighttime)
Dispossesses
Print petitions
Calculate when able to go to next step

Docket Ordering Workflow:

1) On the web, client is notified that warrant can be ordered

2) When client responds, the marshal is automatically notified

3) Marshal enters the docket number

4) Attorney is automatically notified that the warrant can be ordered.

Internal processing:
Facsimiles and e-mails can be identified
Proper office staff people can be assigned to complete the documents
The correct events are automatically entered in the case with the completion of each document

Nighttime Processing:
Determine age of items, and insert appropriate event in the case to move the case forward.
Based on rules tables, send out alerts and status reports to agents, marshal and attorneys. Ability to send specific reports to multiple facsimile or e-mail locations.

Aging of events taking into account national and local holidays.

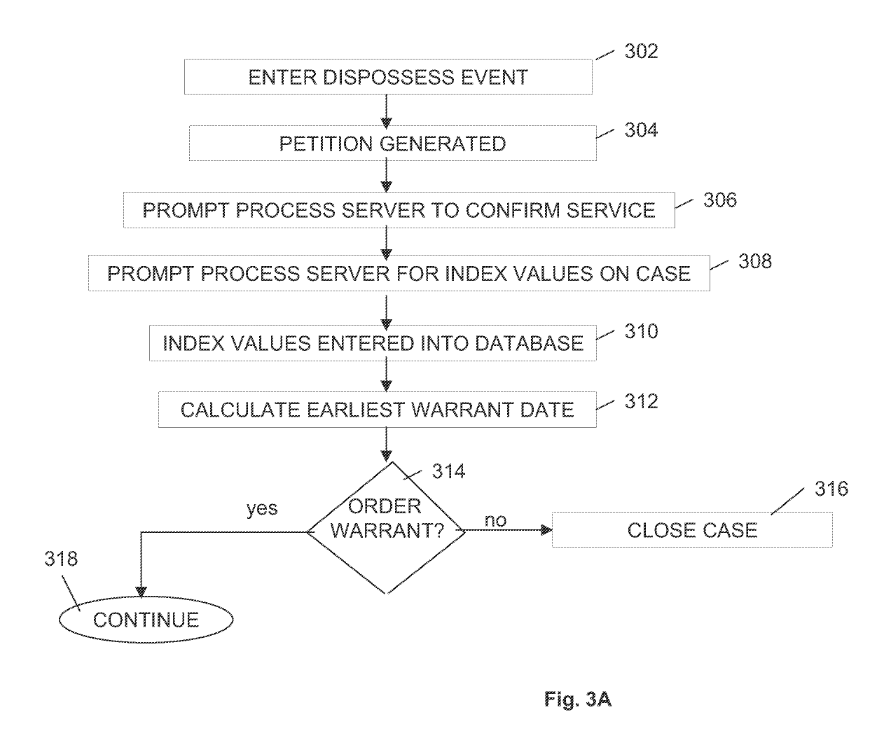

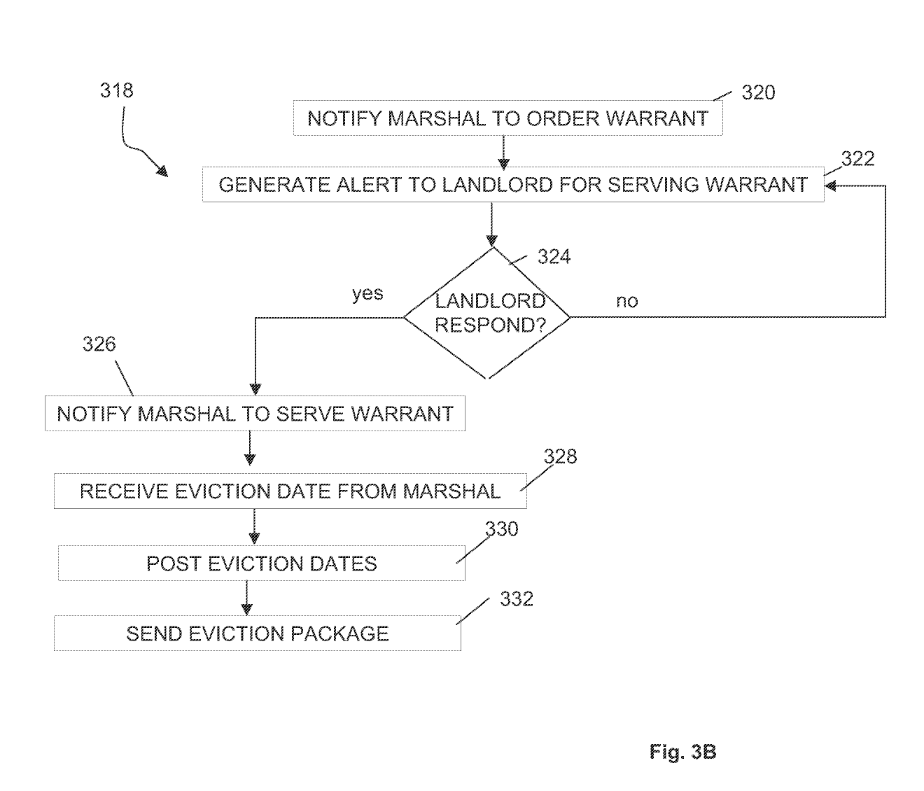

Continuing now with reference to the drawings, FIGS. 3A and 3B illustrate an example flow chart of a simplified process identifying case initiation through the order warrant phase. At step 302, staff personnel submit information associated with a dispossess event. At step 304, a petition document is generated for distribution to an attorney. At step 306, the process server is prompted to confirm that petition has been served. Thereafter, the process server is prompted, such as via e-mail, to transmit index numbers on cases (step 308). A backend workflow router detects when the process server's facsimile with the index numbers arrives, and provides a screen for the staff to enter the numbers on the case (step 310).

Continuing with reference to the flowchart in FIG. 3A, upon receipt of the Index number, the automated event entry engine calculates and records the earliest date when a warrant may be ordered (step 312). Thereafter, at step S314, when the warrant order date is reached, a managing agent (who may be the landlord) is preferably queried, such as via e-mail, whether he would like to order the warrant. If the agent/landlord responds on the web in the negative, the case is preferably closed (step 316). If the Agent/Landlord responds on the web in the affirmative, then the process continues to step 318 (FIG. 3B).

Continuing with reference to the flowchart in FIG. 3B (step 318), once a warrant is issued, the system tracks to ensure that the warrant is received by the marshal. The marshal may be notified (e.g., via the web and e-mail) that docket(s) need to be ordered for the case (step 320). In an embodiment, the number of dockets to be purchased for the case is predetermined, and the marshal may be repeatedly prompted until the requisite number of dockets has been purchased. An alert is generated and transmitted to the agent/landlord requesting whether the warrant should be served (step 322). Thereafter, a determination is made whether the agent/landlord has responded (step 324). If not, then the process loops back to step 322 and an alert is generated for the agent/landlord to respond whether to order the warrant should be served. If, alternatively, the agent/landlord responds that the warrant should be served, then the process branches to step 326, and the marshal is instructed to serve the warrant.

In accordance with the present application, the marshal has access to all necessary materials for successful service of the warrant. Once served, the process branches to step 328 and the marshal's eviction date is received and, thereafter, posted at step S330. Moreover, an eviction package of materials is sent out to the client, for example, that includes an affidavit and other paperwork needed for an eviction to take place, along with a checklist and other information regarding eviction dates (step 332). Examples of information on the checklist include paperwork associated with rent, trucks, contact information for the marshal, affidavit and notarized as necessary.

Thus, as shown in accordance with the flowchart and FIGS. 3A and 3B, the teachings herein reduce a likelihood that an eviction is interrupted or unsuccessful. This is at least in part due to the efficient and complete handling and distribution of materials needed for an eviction to occur.

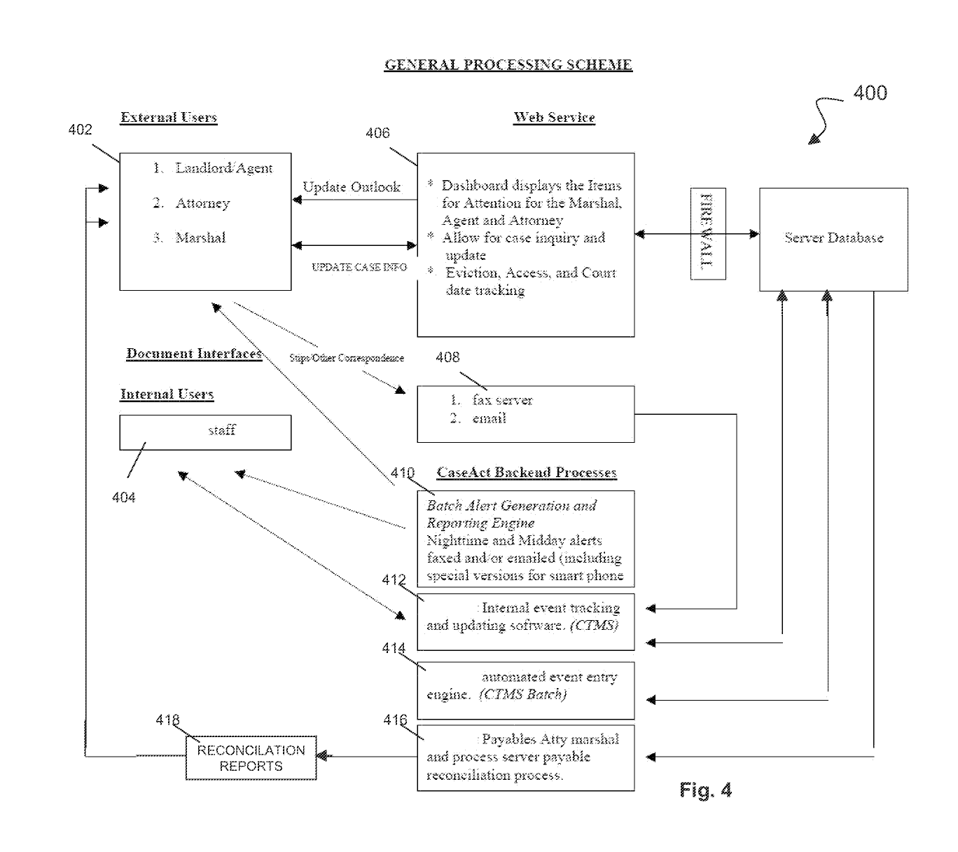

FIG. 4 is another flow chart illustrating processing scheme 400 associated with an embodiment. In the example shown in FIG. 4, “external users” 402 and “internal users” 404 interface with the hardware and software systems and methods in connection with tenant dispute-related processes. Dashboard functionality 406, such as described above, is provided for, among other things, displaying items, responding to case inquiries and disputes, access and court date tracking Correspondence functionality 408 is provided, for example, via facsimile server and e-mail server. Furthermore, back-end processes are provided, for example, via batch alert generation and reporting engine 410, internal event server and management (or update) software (“CTMS”) 412, automated event entry engine 414 and payables engine 416. Reconciliation reports are preferably generated and transmitted, as suitable (418). Thus, various functionality such as described herein is provided by the processing scheme 400 substantially as illustrated in the example embodiment shown in FIG. 4.

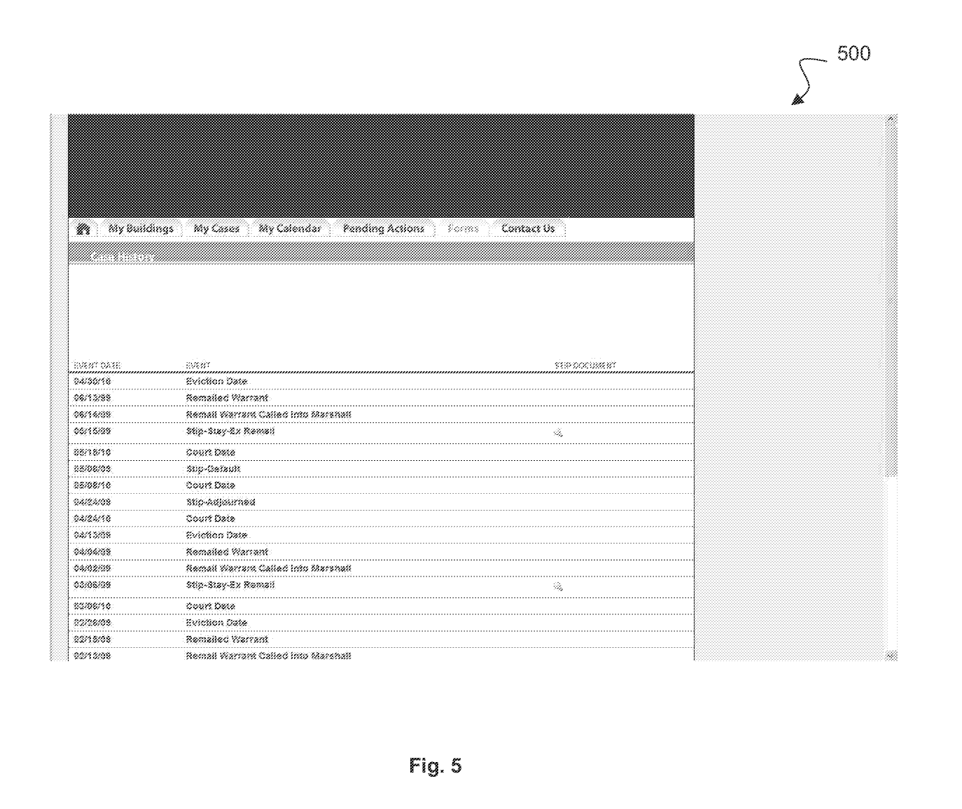

FIGS. 5-11 illustrate example screen displays in accordance with an embodiment of the present application.

FIG. 5 illustrates an example display 500 that represents a case history for a particular matter, in accordance with an embodiment.

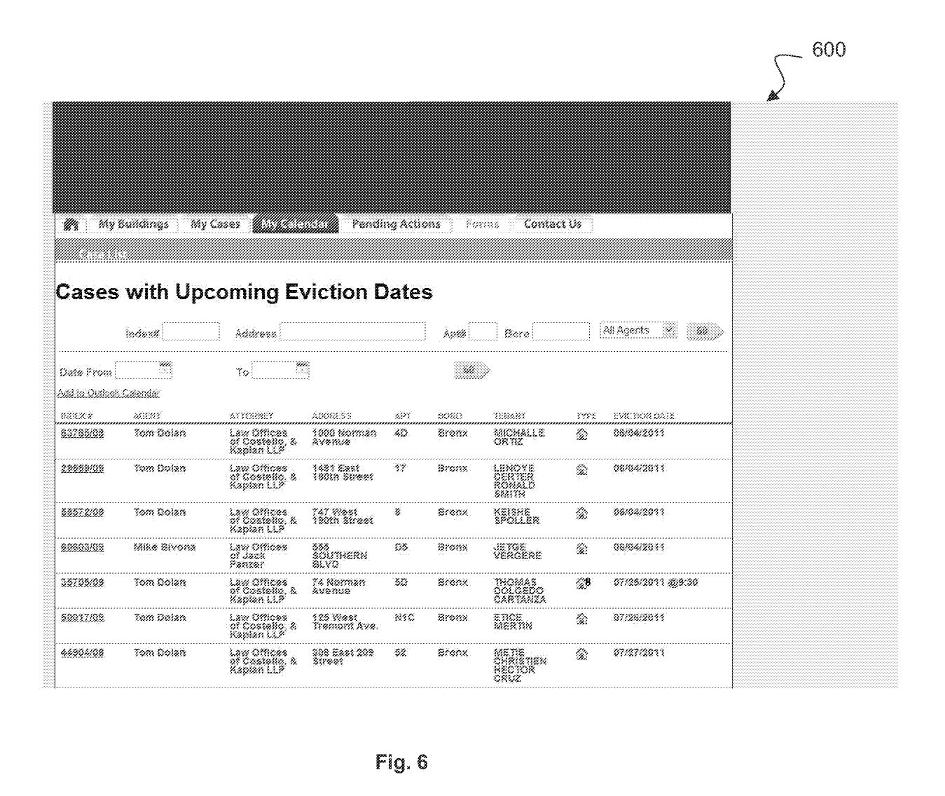

FIG. 6 illustrates an example display 600 that lists cases with upcoming eviction dates, in accordance with an embodiment.

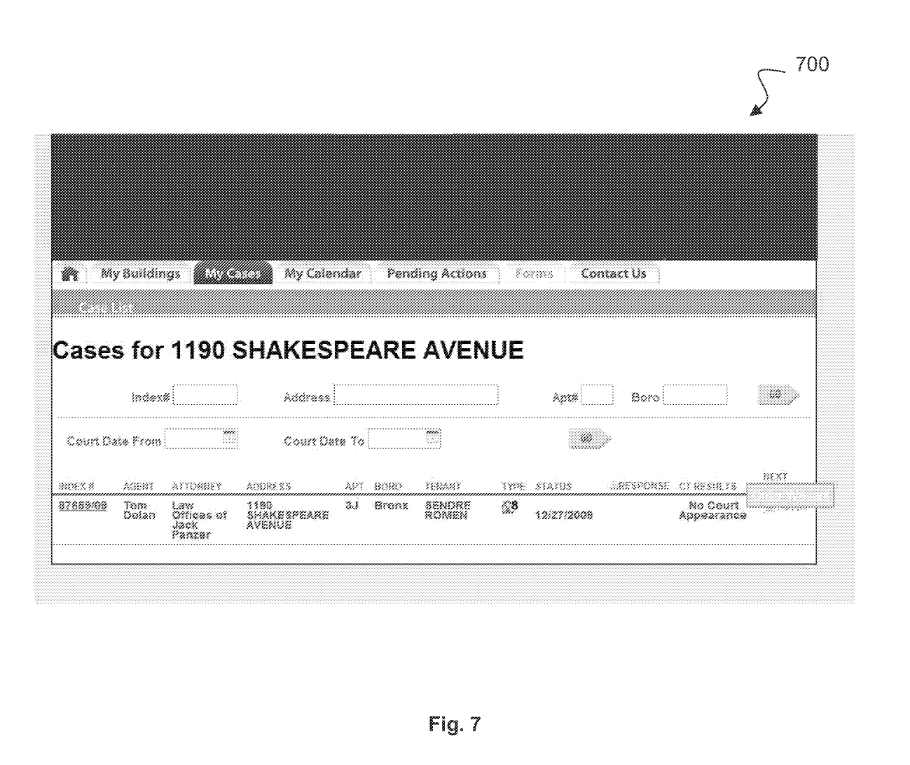

FIG. 7 illustrates an example display 700 that lists cases for a respective address, and further demonstrates a selection device (e.g., mouse) “hover” feature indicating next steps to be taken, in accordance with an embodiment.

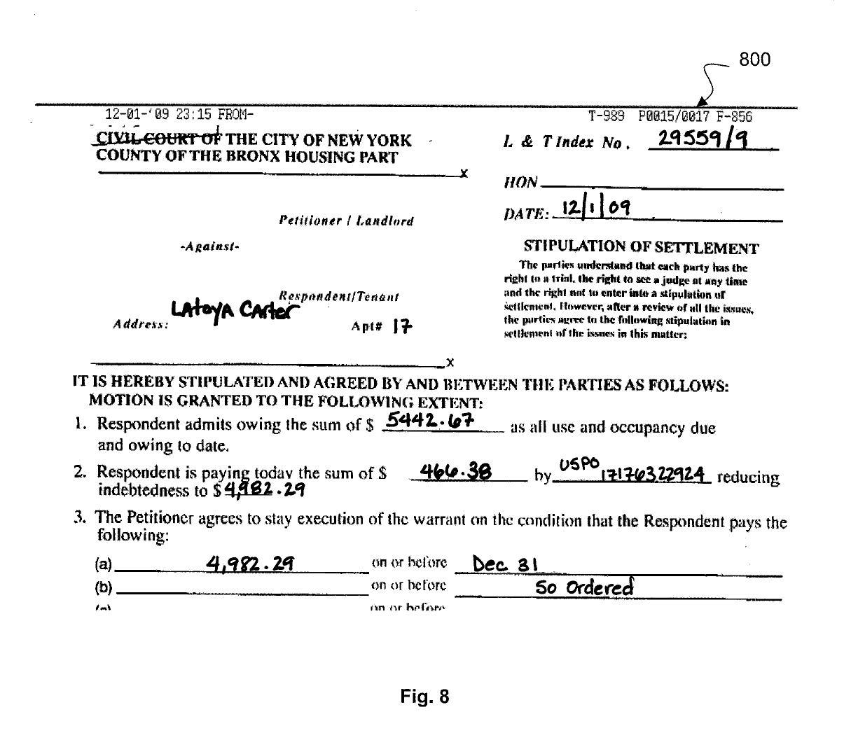

FIG. 8 illustrates an example display 800 that represents an example stipulation, in accordance with an embodiment.

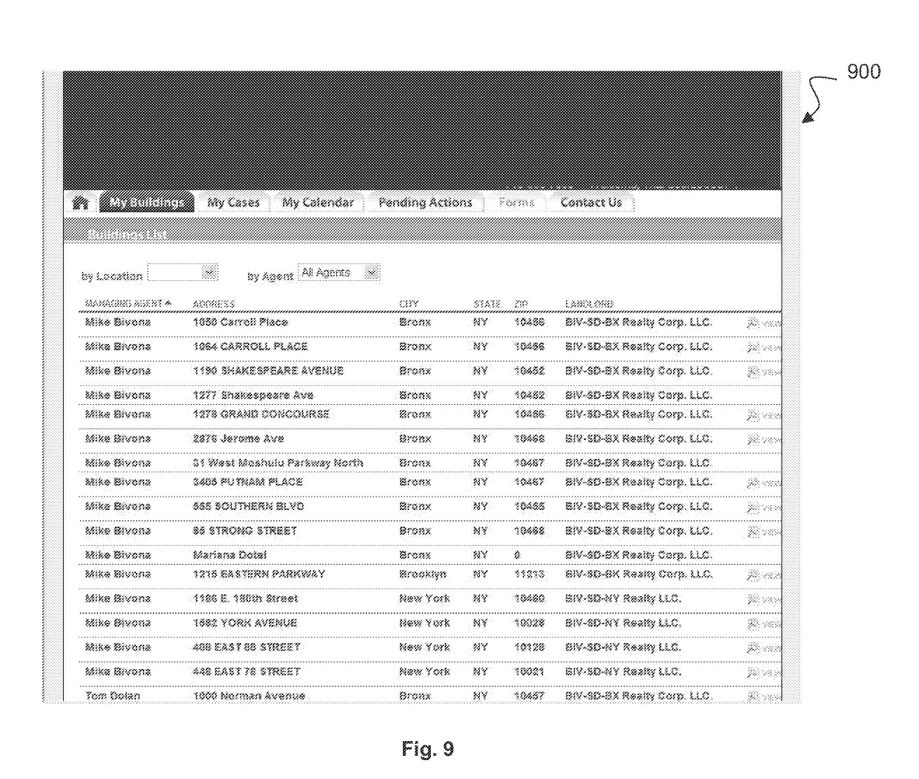

FIG. 9 illustrates an example display 900 that lists locations by agent for upcoming cases, in accordance with an embodiment.

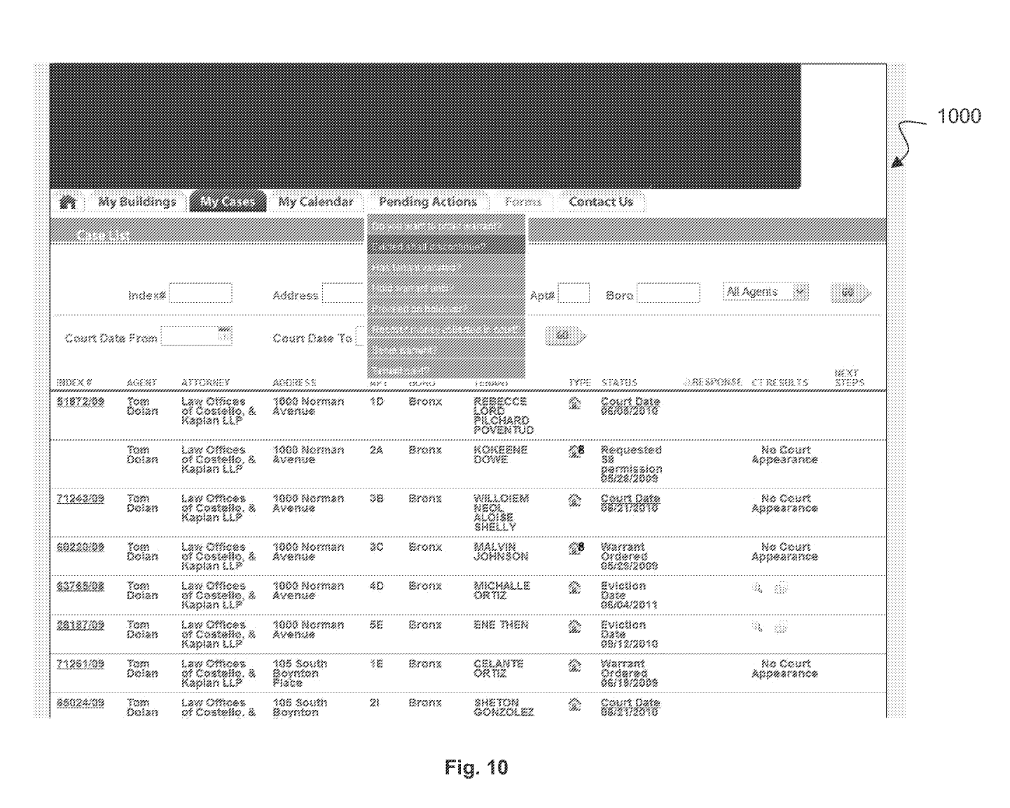

FIG. 10 illustrates an example display 1000 for selecting pending actions for all cases. In the example shown in display 1000, a selection for identifying that an evicted will discontinue is highlighted. Other options include ordering a warrant, indicating that a tenant has vacated, defining how long to hold a warrant, proceed on a holdover, recover money collected in court, whether to server a warrant and whether a tenant is paid.

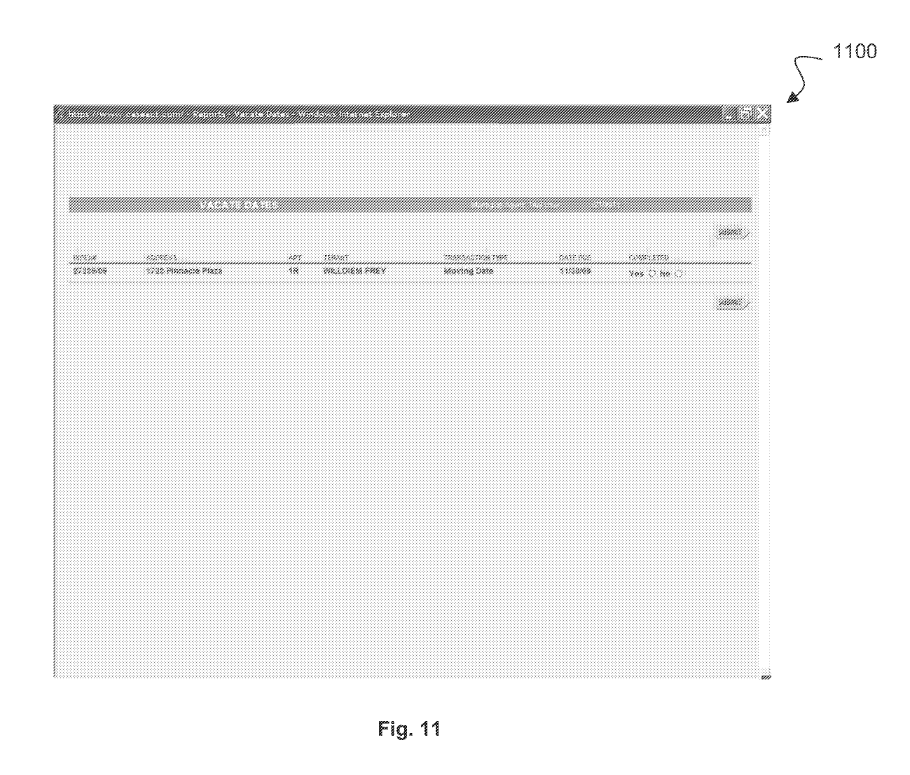

FIG. 11 illustrates an example display 1100 that lists upcoming vacate dates, in accordance with an embodiment.

Thus, and as shown in connection with FIGS. 5-11, a convenient and versatile user interface is provided for receiving information from a plurality of parties, as well as for managing and providing the information for users. Furthermore, documents are produced for all associated parties as needed, during each phase of resolving a landlord tenant matter, for facilitating collection of tenant arrears or otherwise reclaiming property, which may include evictions of tenants.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A method for implementing a resolution to a landlord tenant dispute, the method comprising:
a) storing, on one or more processor readable media that are operatively coupled to one or more processors, at least one database comprising:
i) electronic party information including information representing a plurality of parties respectively associated with a plurality of disputes;
ii) electronic legal form information representing templates for legal forms; and
iii) electronic case information representing a plurality of dispute cases;
b) receiving, by the one or more processors from a first computing device, first electronic case information representing a dispute;
c) generating, by the one or more processors using at least some of the electronic legal form information, a petition for evicting at least one tenant associated with the dispute;
d) transmitting the petition, by the one or more processors, to a second computing device associated with a process server;
e) receiving, by the one or more processors, from at least one of the second computing device and a third computing device, second electronic case information representing additional information associated with the dispute;
f) determining, by the one or more processors based at least on the first and second electronic case information, one or more actions and corresponding schedules for resolving the dispute;
g) providing over a communication network, by the one or more processors and as a function of the determining, at least one of:
i) one or more copies of court documents associated with the dispute;
ii) the one or more actions and corresponding schedules; and
iii) the first electronic case information;
h) tracking, by the one or more processors, that each of the one or more actions is completed;
i) generating and transmitting one or more alerts representing that at least one of the one or more actions is coming due or is past due to a computing device associated with a party associated with the at least one of the one or more actions; and
j) ordering, by the one or more processors, a warrant for implementing an eviction after each of the one or more actions is complete.

2. The method of claim 1, wherein the additional information represents at least one of a stipulation, a court order, and a decision associated with the eviction.

3. The method of claim 1, wherein the plurality of parties include one or more of an agent respectively associated with at least one landlord, a tenant, an attorney, a marshal, and a process server.

4. The method of claim 1 wherein the electronic legal form information represents at least one of a petition, warrant, motion, and affidavit.

5. The method of claim 1, wherein the step (g) providing is in at least one Internet web page.

6. The method of claim 5, wherein the at least one Internet web page comprises at least one dashboard interface.

7. The method of claim 6, wherein the at least one dashboard interface comprises an attorney dashboard, a marshal dashboard and a landlord dashboard.

8. The method of claim 7, wherein the marshal dashboard provides one or more of:
i) one or more evictions dockets to be purchased;
ii) one or more evictions waiting for a warrant to be served;
iii) one or more evictions in which a warrant has been served but no eviction date has been scheduled; and
iv) one or more evictions that are scheduled for eviction within a predetermined time frame.

9. The method of claim 7, wherein the attorney dashboard provides one or more of:
i) a list of tenants to receive a warrant for eviction;
ii) one or more evictions in which one or more unfinished actions are scheduled to be taken; and
iii) one or more evictions having payments due.

10. The method of claim 6, wherein the at least one dashboard interface comprises one or more of electronic status information associated the eviction, electronic calendar information representing one or more dates associated with the one or more actions, and at least one data input control for receiving information associated with the eviction.

11. The method of claim 1, further comprising outputting information associated with eviction to one or more computing devices.

12. The method of claim 1, further comprising repeating steps b)-j) for a second dispute.

13. A system for implementing a resolution to a landlord tenant dispute, the system comprising:
one or more processor readable media that are operatively coupled to one or more processors;
at least one database stored on the one or more processor readable media comprising:
i) electronic party information including information representing a plurality of parties respectively associated with a plurality of disputes;
ii) electronic legal form information representing templates for legal forms; and
iii) electronic case information representing a plurality of dispute cases;
wherein the one or more processors are programmed and configured to perform the following steps:
receive from a first computing device, first electronic case information representing a dispute;
generate, using at least some of the electronic legal form information, a petition for evicting at least one tenant associated with the dispute;
transmit the petition to a second computing device associated with a process server;
receive, from at least one of the second computing device and a third computing device, second electronic case information representing additional information associated with the dispute;
determine, based at least on the first and second electronic case information, one or more actions and corresponding schedules for resolving the dispute;
provide, over a communication network, as a function of the determining, at least one of:
i) one or more copies of court documents associated with the dispute;
ii) the one or more actions and corresponding schedules; and
iii) the first electronic case information;
track that each of the one or more actions is completed;
generate and transmit one or more alerts representing that at least one of the one or more actions is coming due or is past due to a computing device associated with a party associated with the at least one of the one or more actions; and
order a warrant for implementing an eviction after each of the one or more actions is complete.
